(19) United States
(12) Patent Application Publication
(10) Pub. No.: US 2025/0316417 A1
(43) Pub. Date: Oct. 9, 2025

(54) TRANSFORMER

(71) Applicant: KABUSHIKI KAISHA TOYOTA JIDOSHOKKI, Aichi (JP)

(72) Inventors: Kenichi NAGAYOSHI, Aichi (JP); Naoki IWATA, Aichi (JP)

(73) Assignee: KABUSHIKI KAISHA TOYOTA JIDOSHOKKI, Aichi (JP)

(21) Appl. No.: 19/169,565

(22) Filed: Apr. 3, 2025

(30) Foreign Application Priority Data
Apr. 9, 2024 (JP) 2024-062790

(51) Int. Cl. H01F 27/34; H01F 3/14; H01F 27/24

(52) U.S. Cl. CPC H01F 27/346; H01F 3/14; H01F 27/24; H01F 2027/348

(57) ABSTRACT

A transformer includes a core having a center leg portion extending in a first direction and a side leg portion provided away from the center leg portion in a second direction that intersects with the first direction, a primary winding wound around the center leg portion, a secondary winding provided apart from the primary winding in the first direction and wound around the center leg portion, and a path core that forms, together with the core, a magnetic path through which leakage magnetic flux passes, the path core extending in the second direction and being provided between the primary winding and the secondary winding. The path core is disposed so that a plurality of gaps is formed in a section that extends from the center leg portion to the side leg portion through the path core in the magnetic path.

### CROSS-REFERENCE OF THE RELATED APPLICATION

This application claims priority to Japanese Patent Application No. 2024-062790 filed on Apr. 9, 2024, the entire disclosure of which is incorporated herein by reference.

### BACKGROUND ART

The present disclosure relates to a transformer.

There is known a transformer that includes a path core for leakage of magnetic flux, the path core being provided between a primary winding and a secondary winding (for example, see Japanese Patent Application Publication No. S59-047722). In the transformer described in the Publication, two E-shaped cores each have a center leg portion and two side leg portions and face each other, and the path core extends from a position between the center leg portions of the two E-shaped cores toward the opposite side leg portions of one of the E-shaped cores.

In the transformer described in the Publication, a gap is formed between the path core and each side leg portion. Leakage magnetic flux of magnetic flux generated by current flowing through each winding passes through a loop path from the center leg portion through the path core, the gap, and the side leg portion back to the center leg portion in this order. Since magnetic flux passes through a path of least magnetic reluctance, the leakage magnetic flux passes closer to each winding than to an extension of the path core. As a result, the leakage magnetic flux crosses each winding, which may generate eddy current losses.

The present disclosure will describe a transformer in which an eddy current loss is reduced.

### SUMMARY

In accordance with an aspect of the present disclosure, there is provided a transformer that includes a core having a center leg portion extending in a first direction and a side leg portion provided away from the center leg portion in a second direction that intersects with the first direction, a primary winding wound around the center leg portion, a secondary winding provided apart from the primary winding in the first direction and wound around the center leg portion, and a path core that forms, together with the core, a magnetic path through which leakage magnetic flux passes, the path core extending in the second direction and being provided between the primary winding and the secondary winding. The path core is disposed so that a plurality of gaps is formed in a section that extends from the center leg portion to the side leg portion through the path core in the magnetic path.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a perspective view illustrating a schematic configuration of a transformer according to an embodiment;

FIG. 2 is a cross-sectional view taken along a line II-II illustrated in FIG. 1;

FIG. 3 is a view schematically illustrating paths of leakage magnetic flux in the transformer illustrated in FIG. 1;

FIG. 4 is a view schematically illustrating paths of leakage magnetic flux in a transformer according to a comparative example; and

FIG. 5 is a cross-sectional view illustrating a schematic configuration of a transformer according to another embodiment.

### DETAILED DESCRIPTION OF THE PREFERRED EMBODIMENTS

The following will describe a transformer according to an embodiment with reference to the accompanying drawings. In the description of the drawings, identical or substantially identical components have the same reference numerals, and are not reiterated. An XYZ coordinate system may be illustrated in the drawings. A Y-axis direction is a direction that intersects with (e.g., is perpendicular to) an X-axis direction (second direction) and a Z-axis direction (first direction). The Z-axis direction is a direction that intersects with (e.g., is perpendicular to) the X-axis direction and the Y-axis direction. In the following description, as an example, the X-axis direction is defined as a left-right direction (width direction), the Y-axis direction is defined as a front-rear direction (depth direction), and the Z-direction is defined as an up-down direction (height direction). The X-axis direction, the Y-axis direction, and the Z-axis direction are not limited to the above-described directions.

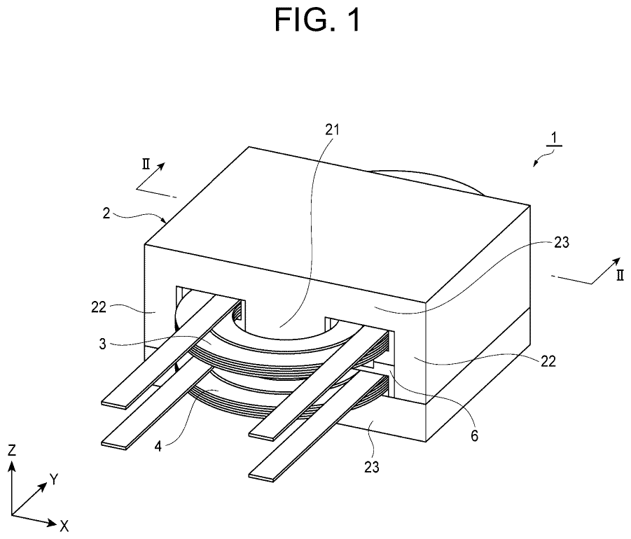

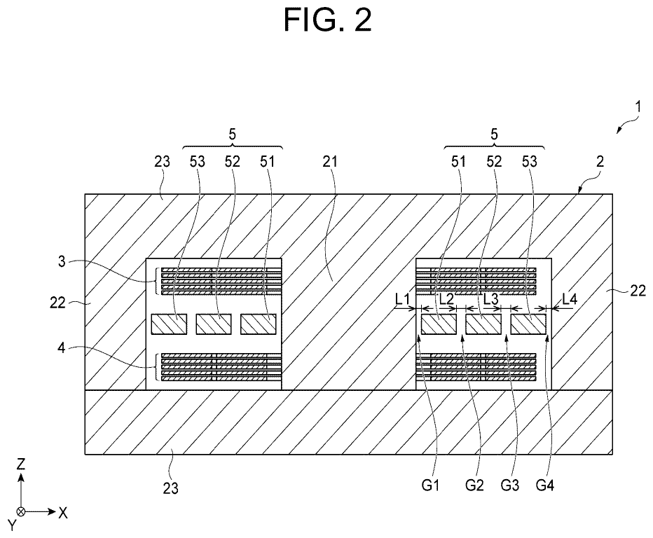

The following will describe a schematic configuration of the transformer according to the embodiment with reference to FIGS. 1 and 2. FIG. 1 is a perspective view illustrating the schematic configuration of the transformer according to the embodiment. FIG. 2 is a cross-sectional view taken along a line II-II illustrated in FIG. 1. A transformer 1 illustrated in FIGS. 1 and 2 is a device that changes voltage levels, and includes a core 2, a primary winding 3, a secondary winding 4, path cores 5, and bobbins 6. Note that illustrations of the bobbins 6 are omitted in FIG. 2.

The core 2 is a magnetic body that forms magnetic paths. The core 2 has a center leg portion 21, a pair of side leg portions 22, and a pair of coupling portions 23. The center leg portion 21 and the pair of the side leg portions 22 each extend in the up-down direction. The center leg portion 21 and the pair of the side leg portions 22 are arranged in substantially parallel to each other. The pair of the side leg portions 22 is provided apart from the center leg portion 21 on opposite sides thereof in the left-right direction. That is, the center leg portion 21 is interposed between the pair of the side leg portions 22. The pair of the coupling portions 23 is portions that connect the pair of the side leg portions 22 to the center leg portion 21. The coupling portions 23 each have a flat plate shape. One of the coupling portions 23 connects one end of the center leg portion 21 to one end of each of the side leg portions 22. The other of the coupling portions 23 connects the other end of the center leg portion 21 to the other end of each of the side leg portions 22.

In the present embodiment, the core 2 is an EI-core formed of an E-shaped core member and an I-shaped core member; however, the shape of the core 2 is not limited thereto. The core 2 may be an EE-core or a PQ-core.

The primary winding 3 and the secondary winding 4 are formed by winding a long conductive member in a spiral shape. The primary winding 3 and the secondary winding 4 are wound around the center leg portion 21. The secondary winding 4 is provided apart from the primary winding 3 in the up-down direction. In the present embodiment, the primary winding 3 and the secondary winding 4 are edgewise coils each formed by winding a copper line having a flat plate shape so that a thickness direction of the copper line coincides with an axial direction of the coil. The conductive member forming the primary winding 3 and the secondary winding 4 is not limited to the copper line having the flat plate shape.

In each of the primary winding 3 and the secondary winding 4, the conductive member is wound so that the number of turns per layer is set to a predetermined number of turns. In the present embodiment, in each of the primary winding 3 and the secondary winding 4, the conductive member is wound in five layers with two turns per layer; however, the number of turns per layer of the primary winding 3 and the secondary winding 4 may be changed as appropriate. Note that the layer in the winding refers to the predetermined number of turns of the conductive member, and corresponds to each layer in a cross-section illustrated in FIG. 2.

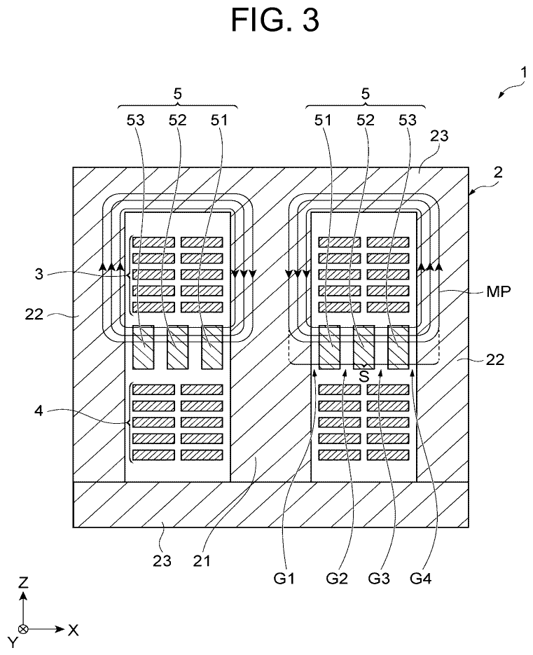

Each of the path cores 5 is a magnetic body forming, together with the core 2, a magnetic path MP (see FIG. 3) through which leakage magnetic flux passes. The path cores 5 extend in the left-right direction and are provided between the primary winding 3 and the secondary winding 4 in the up-down direction. Each of the path cores 5 is disposed so that a plurality of gaps is formed in a section S. The section S is a section that extends from the center leg portion 21 to each of the side leg portions 22 through a corresponding one of the path cores 5 in the magnetic path MP. Note that each gap is a portion of the magnetic path MP in which there is no magnetic body. In the present embodiment, there is an air layer or a part of a corresponding one of the bobbins 6 in each gap.

Although there are two path cores 5 in the present embodiment, the following description will focus on only one of the two path cores 5 and the surrounding configuration of the path core 5 for ease of explanation.

More specifically, the path core 5 includes a plurality of segments between the center leg portion 21 and the corresponding one of the side leg portions 22. The plurality of the segments is arranged apart from each other in the left-right direction. In the present embodiment, the path core 5 has three segments (segments 51, 52, 53) between the center leg portion 21 and the side leg portion 22. The three segments are arranged in an order of the segment 51 (first segment), the segment 52, and the segment 53 (second segment) from the center leg portion 21 toward the side leg portion 22. The segment 51 is closest to the center leg portion 21 of the three segments. The segment 52 is located in the middle of the three segments. The segment 53 is closest to the side leg portion 22 of the three segments.

A gap G1 (first gap) is formed between the segment 51 and the center leg portion 21. A gap G2 (third gap) is formed between the segment 51 and the segment 52. A gap G3 (third gap) is formed between the segment 52 and the segment 53. A gap G4 (second gap) is formed between the segment 53 and the side leg portion 22. In other words, the plurality of the gaps formed in the section S includes the gap G1, the gap G2, the gap G3, and the gap G4. The gap G1 is closest to the center leg portion 21 of the plurality of the gaps formed in the section S. The gap G4 is closest to the side leg portion 22 of the plurality of the gaps formed in the section S. The gaps G2 and G3 are formed between the gap G1 and the gap G4 in the left-right direction.

A length (gap length L1) of the gap G1 in the left-right direction is substantially equal to a length (gap length L4) of the gap G4 in the left-right direction. A length (gap length L2) of the gap G2 in the left-right direction is substantially equal to a length (gap length L3) of the gap G3 in the left-right direction. The gap length L1 is shorter than the gap length L2 and the gap length L3, and the gap length L4 is shorter than the gap length L2 and the gap length L3. A leakage inductance of the transformer 1 depends on a sum of the lengths (gap lengths) along the magnetic path MP of the gaps formed on the magnetic path MP. Accordingly, the gap length of each gap formed in the section S is determined so that a desired leakage inductance is obtained.

The bobbins 6 are members that hold the primary winding 3 and the secondary winding 4. The bobbins 6 are each made of an insulating material. Examples of the insulating material of the bobbins 6 includes resin such as plastic. The bobbins 6 electrically insulate the primary winding 3 from the secondary winding 4 and electrically insulate the primary winding 3 and the secondary winding 4 from the core 2. The path core 5 is housed in each of the bobbins 6. The bobbins 6 each hold the segments while fixing positions of the segments. Note that the core 2, the primary winding 3, the secondary winding 4, and the path core 5 may be held by an integrated injection mold formed by injection molding or may be held by potting, instead of the bobbins 6.

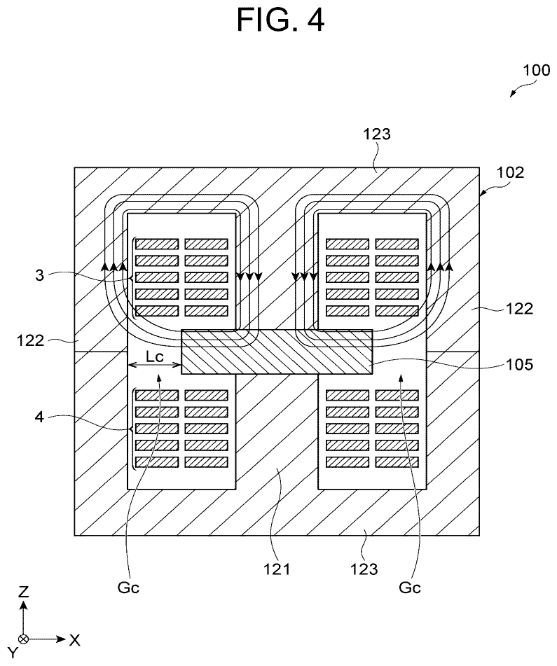

The following will describe operation and advantageous effects of the transformer 1 with reference to FIGS. 3 and 4. FIG. 3 is a view schematically illustrating paths of the leakage magnetic flux in the transformer illustrated in FIG. 1. FIG. 4 is a view schematically illustrating paths of leakage magnetic flux in a transformer according to a comparative example. For ease of explanation, a ratio of a dimension in the X-axis direction to a dimension in the Z-axis direction of each transformer in FIGS. 3 and 4 is different from that in FIG. 2. A transformer 100 illustrated in FIG. 4 is different from the transformer 1 mainly in that the transformer 100 includes a core 102 and a path core 105 instead of the core 2 and the path cores 5.

The core 102 is an EE-core formed of two E-shaped core members. The path core 105 is provided between the center leg portions 121 of the two core members. The path core 105 extends from a position between the center leg portions 121 toward opposite side leg portions 122. A gap Gc is formed between one distal end of the path core 105 and a corresponding one of the side leg portions 122. A length (gap length Lc) of each gap Gc in the left-right direction is substantially equal to the sum (the sum of the gap length L1, the gap length L2, the gap length L3, and the gap length L4) of the gap lengths of the plurality of the gaps formed in the section S of the transformer 1.

In the transformer 100, when a current flows through the primary winding 3, magnetic flux is generated. Here, leakage magnetic flux of the magnetic flux passes through a loop path (magnetic pass) from the center leg portion 121 of the core 102 through the path core 105, the gap Gc, each of the side leg portions 122, and a corresponding one of coupling portions 123 back to the center leg portion 121 in this order. Since magnetic flux passes through a path of least magnetic reluctance, the leakage magnetic flux passes closer to the primary winding 3 than to an extension of the path core 105 in the gap Gc. As a result, the leakage magnetic flux crosses the primary winding 3, which may generate eddy current losses. Similarly, leakage magnetic flux generated by a current flowing through the secondary winding 4 of the transformer 100 passes closer to the secondary winding 4 than the extension of the path core 105 in the gap Gc. As a result, the leakage magnetic flux crosses the secondary winding 4, which may generate eddy current losses.

On the contrary, in the transformer 1, the plurality of the gaps (gap G1, gap G2, gap G3, and gap G4) is formed in the section S. That is, although a gap with a gap length substantially equal to the gap length Lc of the gap Gc of the transformer 100 is required in order to obtain a desired leakage inductance, in the transformer 1, the gaps in the transformer 1 are formed apart from each other so that the sum of the gap lengths of the gaps is substantially equal to the gap length Lc. In the transformer 1, the leakage magnetic flux generated by the current flowing through the primary winding 3 passes through the loop path (magnetic path MP) from the center leg portion 21 through the gap G1, the segment 51, the gap G2, the segment 52, the gap G3, the segment 53, the gap G4, the side leg portion 22, and the coupling portion 23 back to the center leg portion 21 in this order.

Here, as a gap length of a gap formed in the section S is shorter, the leakage magnetic flux passing closer to the primary winding 3 than to the extension of the path core 5 (segments) decreases in the gap. The sum of the gap length L1, gap length L2, gap length L3, and gap length L4 is substantially equal to the gap length Lc. Accordingly, the gap length of any of the gaps formed in the section S is shorter than the gap length Lc. Thus, in any of the gap G1, the gap G2, the gap G3, and the gap G4, an amount of the leakage magnetic flux passing closer to the primary winding 3 than to the extension of the path core 5 (segments) is less than that of the leakage magnetic flux passing closer to the primary winding 3 than to the extension of the path core 105 in the gap Gc of the transformer 100. As a result, in the transformer 1, the amount of the leakage magnetic flux (magnetic flux density) crossing the primary winding 3 decreases as compared to the transformer 100.

Furthermore, in the transformer 1, positions where the leakage magnetic flux crosses the primary winding 3 are apart from each other, so that the magnetic flux density of the leakage magnetic flux crossing the primary winding 3 further decreases, as compared to the transformer 100. Similarly, in the transformer 1, the magnetic flux density of the leakage magnetic flux crossing the secondary winding 4 decreases as compared to the transformer 100. Since an eddy current loss is proportional to a square of the magnetic flux density, the eddy current losses in the transformer 1 are reduced as compared to the transformer 100.

The segment 51, the segment 52, and the segment 53 are arranged apart from each other in the left-right direction, so that the gap is formed between any two adjacent segments in the left-right direction. Thus, the plurality of the gaps (gap G1, gap G2, gap G3, and gap G4) is formed in the section S.

The leakage magnetic flux takes a shortcut at positions where a direction of the magnetic path MP changes. For example, the leakage magnetic flux tends to take the shortcut between the center leg portion 21 and the path core 5 (i.e., gap G1) and between the path core 5 and the side leg portion 22 (i.e., gap G4). For example, the leakage magnetic flux generated by the current flowing through the primary winding 3 does not turn around a corner formed of the center leg portion 21 and the extension of the path core 5 when the leakage magnetic flux passes from the center leg portion 21 toward the path core 5, but tends to pass through an air layer closer to the primary winding 3 than the corner. Similarly, the leakage magnetic flux generated by the current flowing through the primary winding 3 does not turn around a corner formed of the side leg portion 22 and the extension of the path core 5 when the leakage magnetic flux passes from the path core 5 toward the side leg portion 22, but tends to pass through an air layer closer to the primary winding 3 than the corner.

To address this problem, in the transformer 1, the gap length L1 of the gap G1 where the leakage magnetic flux tends to take the shortcut is shorter than the gap length L2 and the gap length L3, so that the leakage magnetic flux that takes the shortcut in the gap G1 decreases. Similarly, the gap length L4 of the gap G4 where the leakage magnetic flux tends to take the shortcut is shorter than the gap length L2 and the gap length L3, so that the leakage magnetic flux that takes the shortcut in the gap G4 decreases. Accordingly, the leakage magnetic flux crossing the primary winding 3 and the leakage magnetic flux crossing the secondary winding 4 are further reduced, which further reduces the eddy current losses.

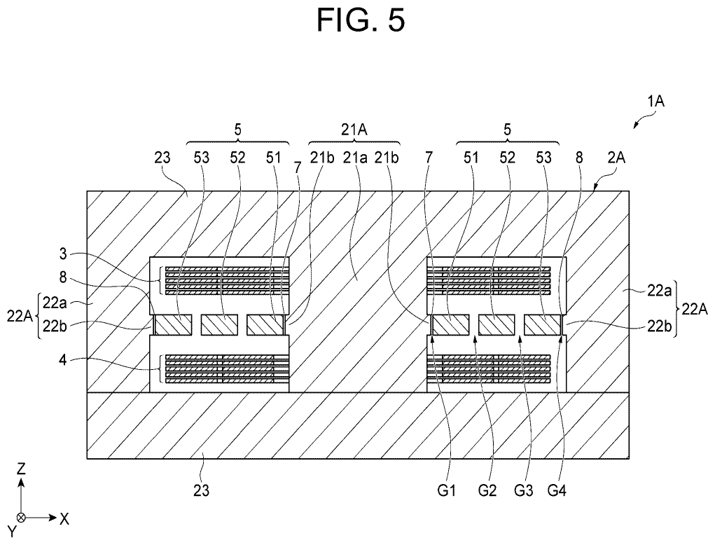

The following will describe a schematic configuration of a transformer according to another embodiment with reference to FIG. 5. FIG. 5 is a cross-sectional view illustrating the schematic configuration of the transformer according to another embodiment. A transformer 1A illustrated in FIG. 5 is different from the transformer 1 mainly in that the transformer 1A includes a core 2A instead of the core 2 and further includes adhesion layers 7 (first adhesion layer) and adhesion layers 8 (second adhesion layer). The core 2A is different from the core 2 mainly in that the core 2A includes a center leg portion 21A and a pair of side leg portions 22A instead of the center leg portion 21 and the pair of the side leg portions 22.

The center leg portion 21A includes a body portion 21a and a pair of protruding portions 21b (first protruding portion). The body portion 21a is a portion corresponding to the center leg portion 21. The pair of the protruding portions 21b is formed on opposite side surfaces of the body portion 21a. The right protruding portion 21b is formed on the right side surface of the body portion 21a and protrudes from the body portion 21a toward the right side leg portion 22A. The left protruding portion 21b is formed on the left side surface of the body portion 21a and protrudes from the body portion 21a toward the left side leg portion 22A. A length (protruding height) of each of the protruding portions 21b in the left-right direction is, for example, equal to or less than a half of a clearance between the primary winding 3 or the secondary winding 4 and the body portion 21a in the left-right direction.

Each of the side leg portions 22A includes a body portion 22a and a protruding portion 22b (second protruding portion). The body portion 22a is a portion corresponding to the side leg portion 22. The protruding portion 22b is formed on a surface of the body portion 22a, which faces the center leg portion 21A, and protrudes from the body portion 22a toward the center leg portion 21A. A length (protruding length) of the protruding portion 22b in the left-right direction is, for example, equal to or less than a half of a clearance between the primary winding 3 or the secondary winding 4 and the body portion 22a in the left-right direction.

Although there are two path cores 5 also in the present embodiment, the following description will focus on only one of the two path cores 5 and the surrounding configuration of the path core 5 for ease of explanation.

The adhesion layer 7 is provided between the segment 51 and the protruding portion 21b, and fixes the segment 51 to the protruding portion 21b. Specifically, the adhesion layer 7 is interposed between a surface of the segment 51, which faces the center leg portion 21A, and a distal surface of the protruding portion 21b. The adhesion layer 7 is, for example, made of epoxy resin-based adhesive. The adhesive of the adhesion layer 7 may contain a soft magnetic material. In the present embodiment, the adhesion layer 7 is present in the gap G1.

The adhesion layer 8 is provided between the segment 53 and the protruding portion 22b, and fixes the segment 53 to the protruding portion 22b. Specifically, the adhesion layer 8 is interposed between a surface of the segment 53, which faces the side leg portion 22A, and a distal surface of the protruding portion 22b. The adhesion layer 8 is, for example, made of epoxy resin-based adhesive. The adhesive of the adhesion layer 8 may contain a soft magnetic material. In the present embodiment, the adhesion layer 8 is present in the gap G4.

Also in the transformer 1A, the same configuration as that of the transformer 1 provides the same advantageous effects similar to those of the transformer 1.

As described above, the leakage magnetic flux tends to take the shortcut at the positions where the direction of the magnetic path MP changes. In the transformer 1A, the center leg portion 21A includes the protruding portions 21b, so that the leakage magnetic flux tends to pass through the protruding portions 21b each having magnetic permeability higher than that of the air layer. This reduces the leakage magnetic flux that takes the shortcut at the positions where the direction of the magnetic path MP changes. Accordingly, the leakage magnetic flux crossing the primary winding 3 and the leakage magnetic flux crossing the secondary winding 4 are further reduced, which further reduces the eddy current losses.

In the transformer 1A, the side leg portion 22A includes the protruding portion 22b, so that the leakage magnetic flux tends to pass through the protruding portion 22b having magnetic permeability higher than that of the air layer. This reduces the leakage magnetic flux that takes the shortcut at the positions where the direction of the magnetic path MP changes. Accordingly, the leakage magnetic flux crossing the primary winding 3 and the leakage magnetic flux crossing the secondary winding 4 are further reduced, which further reduces the eddy current losses.

Since a position between the segment 51 and the protruding portion 21b (i.e., gap G1) is close to the position where the direction of the magnetic path MP changes, the leakage magnetic flux tends to take the shortcut at the position between the segment 51 and the protruding portion 21b. In the transformer 1A, the segment 51 is directly fixed to the protruding portion 21b by the adhesion layer 7 without through the bobbin 6, so that the gap length L1 of the gap G1 between the segment 51 and the protruding portion 21b is made shorter as compared to a case where the bobbin 6 is used. This further reduces the leakage magnetic flux that takes the shortcut. Accordingly, the leakage magnetic flux crossing the primary winding 3 and the leakage magnetic flux crossing the secondary winding 4 are further reduced, which further reduces the eddy current losses.

Since a position between the segment 53 and the protruding portion 22b (i.e., gap G4) is close to the position where the direction of the magnetic path MP changes, the leakage magnetic flux tends to take the shortcut at the position between the segment 53 and the protruding portion 22b. In the transformer 1A, the segment 53 is directly fixed to the protruding portion 22b by the adhesion layer 8 without through the bobbin 6, so that the gap length L4 of the gap G4 between the segment 53 and the protruding portion 22b is made shorter as compared to the case where the bobbin 6 is used. This further reduces the leakage magnetic flux that takes the shortcut. Accordingly, the leakage magnetic flux crossing the primary winding 3 and the leakage magnetic flux crossing the secondary winding 4 are further reduced, which further reduces the eddy current losses.

As described above, the embodiments of the present disclosure have been described in detail; however, the transformer according to the present disclosure is not limited to the above-described embodiments.

For example, the transformer 1 may further include an adhesion layer provided between the center leg portion 21 and the segment 51, and the segment 51 may be fixed to the center leg portion 21 by the adhesion layer. The transformer 1 may further include an adhesion layer provided between the segment 53 and the side leg portion 22, and the segment 53 may be fixed to the side leg portion 22 by the adhesion layer.

The transformers 1, 1A may further include an adhesion layer provided between the segment 51 and the segment 52, and the segment 52 may be fixed to the segment 51 by the adhesion layer. Similarly, the transformers 1, 1A may further include an adhesion layer provided between the segment 52 and the segment 53, and the segment 52 may be fixed to the segment 53 by the adhesion layer.

In the transformer 1A, the core 2A need not include any one of the protruding portions 21b and the protruding portions 22b.

As long as the desired leakage inductance is obtained, the gap length L1, the gap length L2, the gap length L3, and the gap length L4 may be changed as appropriate.

In the transformers 1, 1A, the number of segments of the path core 5 may be two or four or more.

The path core 5 need not be divided into the segments in the section S. For example, the path core 5 may have a plate shape extending in the left-right direction. In this case, in the transformer 1, the path core 5 is provided away from the center leg portion 21 and the side leg portion 22. A sum of a gap length of a gap between the path core 5 and the center leg portion 21 and a gap length of a gap between the path core 5 and the side leg portion 22 is set so that a desired leakage inductance is obtained. Similarly, in the transformer 1A, the path core 5 is provided away from the center leg portion 21A and the side leg portions 22A. A sum of a gap length of a gap between the path core 5 and the center leg portion 21A and a gap length of a gap between the path core 5 and the side leg portion 22A is set so that a desired leakage inductance is obtained. Also in this configuration, as compared to the transformer 100, the leakage magnetic flux crossing the primary winding 3 and the leakage magnetic flux crossing the secondary winding 4 are reduced, which reduces eddy current losses.

### (Supplementary Notes)

### [Clause 1]

A transformer including:
a core having a center leg portion extending in a first direction and a side leg portion provided away from the center leg portion in a second direction that intersects with the first direction;
a primary winding wound around the center leg portion;
a secondary winding provided apart from the primary winding in the first direction and wound around the center leg portion; and
a path core that forms, together with the core, a magnetic path through which leakage magnetic flux passes, the path core extending in the second direction and being provided between the primary winding and the secondary winding, wherein
the path core is disposed so that a plurality of gaps is formed in a section that extends from the center leg portion to the side leg portion through the path core in the magnetic path.

### [Clause 2]

The transformer according to clause 1, wherein
the path core includes a plurality of segments that is arranged apart from each other in the second direction.

### [Clause 3]

The transformer according to clause 2, wherein
the center leg portion has a first protruding portion protruding toward the side leg portion.

### [Clause 4]

The transformer according to clause 3, further including
a first adhesion layer provided between the first protruding portion and a first segment which is one of the plurality of the segments and closest to the center leg portion, the first adhesion layer fixing the first segment to the first protruding portion.

### [Clause 5]

The transformer according to any one of clauses 2 to 4, wherein
the side leg portion includes a second protruding portion protruding toward the center leg portion.

### [Clause 6]

The transformer according to clause 5, further including
a second adhesion layer provided between the second protruding portion and a second segment which is one of the plurality of the segments and closest to the side leg portion, the second adhesion layer fixing the second segment to the second protruding portion.

### [Clause 7]

The transformer according to any one of clauses 1 to 6, wherein
the plurality of the gaps includes a first gap closest to the center leg portion, a second gap closest to the side leg portion, a third gap formed between the first gap and the second gap, and
a length of the first gap in the second direction and a length of the second gap in the second direction are shorter than a length of the third gap in the second direction.

What is claimed is:

1. A transformer comprising:
a core having a center leg portion extending in a first direction and a side leg portion provided away from the center leg portion in a second direction that intersects with the first direction;
a primary winding wound around the center leg portion;
a secondary winding provided apart from the primary winding in the first direction and wound around the center leg portion; and
a path core that forms, together with the core, a magnetic path through which leakage magnetic flux passes, the path core extending in the second direction and being provided between the primary winding and the secondary winding, wherein
the path core is disposed so that a plurality of gaps is formed in a section that extends from the center leg portion to the side leg portion through the path core in the magnetic path.

2. The transformer according to claim 1, wherein
the path core includes a plurality of segments that is arranged apart from each other in the second direction.

3. The transformer according to claim 2, wherein
the center leg portion has a first protruding portion protruding toward the side leg portion.

4. The transformer according to claim 3, further comprising
a first adhesion layer provided between the first protruding portion and a first segment which is one of the plurality of the segments and closest to the center leg portion, the first adhesion layer fixing the first segment to the first protruding portion.

5. The transformer according to claim 2, wherein
the side leg portion includes a second protruding portion protruding toward the center leg portion.

6. The transformer according to claim 5, further comprising
a second adhesion layer provided between the second protruding portion and a second segment which is one of the plurality of the segments and closest to the side leg portion, the second adhesion layer fixing the second segment to the second protruding portion.

7. The transformer according to claim 1, wherein
the plurality of the gaps includes a first gap closest to the center leg portion, a second gap closest to the side leg portion, a third gap formed between the first gap and the second gap, and
a length of the first gap in the second direction and a length of the second gap in the second direction are shorter than a length of the third gap in the second direction.
